(19) United States
(12) Patent Application Publication
(10) Pub. No.: US 2009/0233796 A1
(43) Pub. Date: Sep. 17, 2009

(54) HERBICIDAL COMPOSITION

(75) Inventor: Daniel Joseph North, Basel (CH)

Correspondence Address: SYNGENTA CROP PROTECTION , INC.;PATENT AND TRADEMARK DEPARTMENT, 410 SWING ROAD, GREENSBORO, NC, 27409, US

(73) Assignee: SYNGENTA CROP PROTECTION, INC., Greensboro, NC (US)

(21) Appl. No.: 11/720,614

(22) PCT Filed: Nov. 21, 2005
(86) PCT No.: PCT/GB05/04468

§ 371 Date: Jun. 1, 2007

(30) Foreign Application Priority Data
Dec. 6, 2004 (GB) 0426717.5
Feb. 17, 2005 (GB) 0503346.9

(51) Int. Cl. A01N 43/54; A01P 13/00

(52) U.S. Cl. 504/243

(57) ABSTRACT

A synergistic herbicidal composition comprising; (A) a compound of formula (I), in which R1 is C1 to C3 alkyl or C¹ to C³ haloalkyl. R² is C1 to C3 alkyl, X¹ and X² are halogen and R³ is a C1-6 alkanoic acid 1-6 alkyl ester residue, and: (B) a second herbicide selected from; (B1) paraquat, (B2) glyphosate, (B3) sulfonyurea, (B4) chloroacetamide, (B5) diphenyl ether (B6) triazine (B7) N-phenylphthalimide (B8) glufosinate (B9) phenylpyridazine (B10) triketone (B11) isoxazole (B12) cyclohexanedione oxime (B13) triazolinone (B14) urea (B15) dinitroaniline (B16) pinoxaden or their herbicidally effective salts.

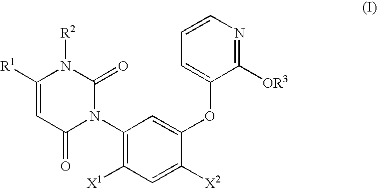

The present invention relates to a herbicidal composition and to a method of controlling the growth of undesirable vegetation using this composition or a combination of its components.

The protection of crops from weeds and other undesirable vegetation is a constantly recurring problem in agriculture. There are an extensive variety of herbicidal chemicals and chemical formulations known for the control of such weeds. Chemical herbicides of many types have been disclosed in the literature and a large number are in commercial use.

U.S. Pat. No. 6,537,948 discloses a broad range of compounds as herbicides. This patent also discloses that these compounds can be used in admixture with a wide range of other agricultural additives, including a long list of other herbicides. We have now discovered that certain selected herbicide mixtures are unexpectedly effective in controlling weeds.

The present invention relates to a herbicidal composition comprising;

(A) a herbicide of formula (I)

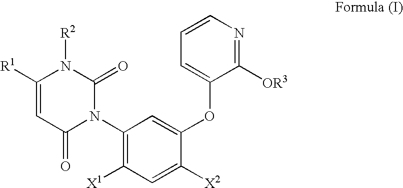

in which R¹ is C1 to C3 alkyl or C1 to C3 haloalkyl, R² is C1 to C3 alkyl, X¹ and X² are halogen and R³ is a C1-6 alkanoic acid C1-6 alkyl ester residue, and:
(B) a second herbicide selected from;
(B1) paraquat
(B2) glyphosate
(B3) a sulfonylurea
(B4) a chloroacetamide
(B5) a diphenyl ether
(B6) a triazine

### (B7) a N-phenylphthalimide

(B8) glufosinate
(B9) a phenylpyridazine
(B10) a triketone
(B11) an isoxazole
(B12) a cyclohexanedione oxime
(B13) a triazolinone
(B14) a urea
(B15) a dinitroaniline
(B16) pinoxaden
or their herbicidally effective salts.

Preferably R¹ is methyl substituted with fluorine, for example trifluoromethyl, chlorodifluoromethyl, difluoromethyl, or ethyl substituted with fluorine, for example, pentafluoroethyl, 1,1-difluoroethyl. Most preferably R¹ is trifluoromethyl.

Preferably R² is methyl or ethyl, more preferably methyl,

In R³, the C1-6 alkanoic acid can be for example ethanoic, propionic, pentanoic or hexanoic acid, preferably ethanoic acid, and the C1-6 alkyl ester is derived from, for example, ethanol, propanol, isopropanol, butanol, isobutanol, tertiary butanol, pentanol, isopentanol, hexanol or isohexanol, preferably methanol or ethanol, more preferably ethanol. Most preferably R³ is —CH₂COOCH₃ or —CH₂COOCH₂CH₃, and particularly preferred is —CH₂COOCH₂CH₃.

X¹ and X² are preferably independently chlorine or fluorine. Most preferably X¹ is fluorine. Most preferably X² is chlorine. The most preferred compound (a) is of Formula II;

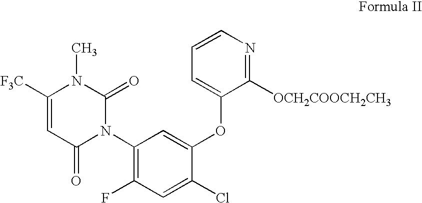

The herbicides (B) are independently known in the art for their effects on plant growth. Many are disclosed in The Pesticides Manual, Thirteenth Edition, 2003, published by The British Crop Protection Council. Numbers in brackets after herbicide names in this application refer to entries in The Pesticides Manual. Many are also commercially available.

Paraquat (B1) is disclosed and described as entry 614, page 742 of The Pesticides Manual.

Glyphosate (B2) is described as entry 419, page 513 of The Pesticides Manual.

In practice, glyphosate is used in the form of a salt, such as an ammonia or organic amine salt or such as an alkali metal salt. Examples of organic amine salts are salts with ethonolamine, isopropylamine or dimethylethanolamine. Examples of alkali metal salts are sodium, potassium or lithium salts. Preferred salts are with potassium, ammonia, isopropylamine or ethanolamine.

Sulfonylureas (B3) are a well-known class of herbicides of the general formula;

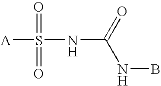

Examples of sulfonylureas are amidosulfuron (22), azimsulfuron (43), bensulfuron-methyl (64), chlorimuron-ethyl (135), chlorsulfuron (147), cinosulfuron (154), cyclosulfamuron (189), ethametsulfuron-methyl (306), ethoxysulfuron (314), flazasulfuron (356), flupyrsulfuron-methyl-sodium (384), foramsulfuron (402), halosulfuron-methyl (426), imazosulfeuron (456), iodosulfuron-methyl-sodium (466), mesosulfuron-methyl (514), metsulfuron-methyl (555), nicosulfuron (577), oxasulfuron (603), primisulfuron-methyl (657), prosulfuron (684), pyrazosulfuron-ethyl (694), rimsulfuron (721), sulfometuron-methyl (751), sulfosulfuron (752), thifensulfuron-methyl (795), triasulfuron (817), tribenuron-methyl (822), trifloxysulfuron-sodium (833), triflusulfuron-methyl (837) and tritosulfuron (843). Preferred sulfonylureas are nicosulfuron, flazasulfinuron, trifloxysulfron and triasulfuron. All of these are described in The Pesticides Manual.

Chloroacetamides (B4) are a well-known class of herbicides of the general formula;

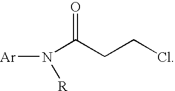

Examples of chloroacetamides are acetochlor (5), alachlor (14), butachlor (100), dimethachlor (258), dimethanamid (260), metazachlor (524), metolachlor (548), S-metolachlor (549), pethoxamid (627), pretilachlor (656), propachlor (667), propisochlor (677), thenylchlor (789). A preferred chloroacetamide is metolachlor, particularly its isomer S-metolachlor.

Diphenyl ethers (B5) are a known class of herbicides including aciflorofen (7), bifenox (75), fluoroglycofen-ethyl (380), fomesafen (401), lactofen (486), oxyfluorfen (610) and aclonifen (8). A preferred difenyl ether is fomesafen.

Triazines (B6) are a well-known class of herbicides which includes ametryn (20), atrazine (37), cyanazine (183), dimethametryn (259), prometon (665), prometryn (666), propazine (672), simazine (730), simetryn (732), terbumeton (774), terbuthylazine (775), terbutryn (776) and trietazine (831). Preferred triazines are simazine and atrazine, more preferred is atrazine.

N-Phenylphthalimides (B7) are a well-known class of herbicides which include cinidon-ethyl (152), flumiclorac-pentyl (375) and flumioxazin (376). Preferred is flumioxazim.

Glufosinate (B8) is described as entry 406 of The Pesticides Manual. Phenylpyridazines (B9) are a well-known class of herbicides which includes pyridate (702).

Triketones (B10) are a well-known class of herbicides which includes sulcotrione (747) and mesotrione (515). Mesotrione is preferred.

Isoxazoles (B11) are a well known class of herbicides including isoxaflutole (479).

Cyclohexanedione oximes (B12) are a well known class of herbicides including alloxydim (18), butroxydim (106), clethodim (155), cycloxydim (190), sethoxydim (726), tepraloxydim (771) and tralkoxydim (811). Clethodim is preferred.

Triazolinones (B13) are a known class of herbicides including amicarbazone (21), azafenidin (S885), carfentrazone-ethyl (212) and sulfentrazone (749). Carfentrazone-ethyl is preferred.

Ureas (B14) are a known class of herbicide including chlorbromuron (S961), chlorotoluron (143), dimefuron (256), diuron (281), fenuron (S1162), fluometuron (378), isoproturon (475), isouron (476), linuron (489), methabenzthiazuron (526), metobenzuron (547), metobromuron (S1287), metoxuron (553), monolinuron (562), neburon (574), siduron (727) and tebuthiuron (765). Diuron is preferred. Dinitroanilines (B15) are a known class of herbicides including benfluraline (59), butralin (105), dinitramine (268), ethalfluralin (305), oryzalin (597), pendimethalin (621) and trifluralin (836). Oryzalin and pendimethalin are preferred.

Pinoxaden (P16) is a new broad spectrum cereals herbicide of the formula;

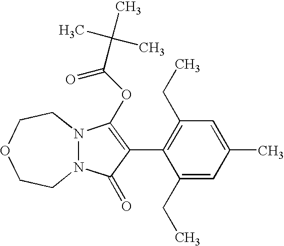

Other herbicides that can also be used as component (B) include aminopyralid, beflubutamid (55), benazolin-ethyl, benefin (59), benflubutamid, bentazone (67), benzfendizone, bilanafos (77), bromoxynil (95), butilate (108), clodinafop-propargyl (156), clomazone (159), clopyralid (162), cloransulam (164), cyhalofop-butyl (195), dicamba (228) and its salts, dichlorprop (324), diclofop-methyl (238), diclosulam (241), difenzoquat (248), diflufenican (251), diflufenzopyr (252), dithiopyr (280), fenoxaprop-P-ethyl (339), fentrazamide (348), flamprop-M (355), florasulam (359), fluazolate (S1165), flucarbazone (364), flufenpyr-ethyl (371), flumiclorac (375), flurtamone (392), fluoroxypyr 390), fluthiacet (395), fluthiamide (369), imazamethabenz-methyl (450), imazamox (451), imazapyr (453), imazaquin (454), imazethapyr (455), ioxynil (467), isoxaben (477), isoxachlortole, isopropazole, ketospiradox, MCPA (499), MCPB (501), mecoprop (503), mecoprop-P (504), picolinafen (646), procarbazone (679), prodiamine (661). Prohexadione (664), prosulfocarb (683), pyraflufen-ethyl (691), pyridafol, quinclorac (712), quinmerac (713), triallate (816), 2,4-DB (217), 2,4-D (211) and its salts.

Still further herbicides that can be used as component (B) are acrolein (10), amitrole (25), ammonium sulfarnate (26), anilofos (31), asulam (36), benfuresate (61), bensulide (65), benzobicyclon (69), benzofenap 70), bispyribac-sodium (82), borax (86), bromacil (90), bromobutide (93), butafenacil (101), butamifos (102), cafenstrole (110), carbetamide (117), chlorflurenol-methyl (133), chloridazon (134), chloroacetic acid (138), chlorpropharn (144), chlorthal-dimethyl (148), cinmethylin (153), clomeprop (160), cumyluron (180), cyanamide (182), cycloate (187), daimuron (213), dalapon (214), dazomet (216), desmedipham (225), dichlobenil (229), dimepiperate (257), dimethenarnid-P (260), dimethipin (261), dimethylarsinic acid (264), dinoterb (272), diphenamid (274), diquat dibromide (276), DNOC (282), endothal (295), EPTC (299), esprocarb (303), ethofumesate (311), etobenzanid (318), ferrous sulfate (353), fluazifop-butyl (361), fluazifop-P-butyl (362), flucetosulfuron, fluchloralin (365), flufenacet (369), flumetsulam (374), flupropanate (383), flurenol (387), fluridone (388), fluorochloridone (389), fosamine (406), haloxyfop (427), haloxyfop-P (428), HC-252 (429), hexazinone (440), imazapic (452), indanofan (462), karbutilate (482), lenacil (487), MCPA-thioethyl (500), mefenacet (505), mefluidide (507), metam (519), metamifop (520), metamitron (521), methylarsonic acid (536), methyldymron (539), methyl isothiocyanate (543), metosulam (552), metribuzin (554), MK-616 (559), molinate (560), naproanilide (571), napropamide (572), naptalam (573), nonanoic acid (583), norflurazon (584), oleic acid (593) (fatty acids), orbencarb (595), oxadiargyl (599), oxadiazon (600), oxaziclomefone (604), pebulate (617), pendimethalin (621), penoxsulam (622), pentachlorophenol (623), pentanochlor (624), pentoxazone (625), petrolium oils (628), phenmedipham (629), picloram (645), piperophos (650), profluazol, profoxydim (663), propanil (669), propaquizafop (670), propham (674), propoxycarbazone-sodium (679), propyzamide (681), pyrazolynate (692), pyrazoxyfen (695), pyribenzoxim (697), pyributicarb (698), pyriftalid (704), pyriminobac-methyl (707), pyrithiobac-sodium (709), quinoclamine (714), quizalofop (717), quizalofop-P (718), simetryn (732), sodium chlorate (734), tar oils (758), 2,3,6-TBA (759), TCA-sodium (760), terbacil (772), thiazopyr (793), thiobencarb (797), tiocarbazil (807), triaziflam (819), triclopyr (827), trifluralin (836), and triflusulfuron-methyl (837).

Preferably (B) is selected from (B1) paraquat, (B2) glyphosate, (B3) a sulfonyl urea, (B4) a chloroanilide or (B10) a triketone, or their herbicidally effective salts. Most preferably (B) is selected from paraquat, glyphosate, triasulfuron, nicosulfuron, S-metolachlor, sulcotrione or their herbicidally effective salts. More than one component (B) can be used.

The compositions of the present invention can provide one or more of a number of advantages over the use of the individual components (A) and (B). The rates of application of the individual components can be markedly reduced while maintaining a high level of herbicidal efficacy. The composition can have a considerably broader weed spectrum against which it is effective than does either of the components alone. The composition can have the potential to control weed species at a low application rate at which the individual compounds alone are ineffective. The composition can have a speed of action which is faster than that which would have been predicted from the speed of the individual components.

The composition contains a herbicidally effective amount of a combination of component (A) and component (B). The term “herbicide” as used herein means a compound that controls or modifies the growth of plants. The term “herbicidally effective amount” means the quantity of such a compound or combination of such compounds that is capable of producing a controlling or modifying effect on the growth of plants.

Controlling or modifying effects include all deviation from natural development, for example: killing, retardation, leaf burn, albinism, dwarfing and the like. The term “plants” refers to all physical parts of a plant, including seeds, seedlings, saplings, roots, tubers, stems, stalks, foliage, and fruits.

The compositions of this invention preferably also comprise an agriculturally acceptable carrier therefor. The compositions of the invention can be formulated as granules, as wettable powders, as emulsifiable concentrates, as powders or dusts, as flowables, as solutions, as suspensions or emulsions, or as controlled release forms such as microcapsules. These formulations can contain as little as about 0.5% to as much as about 95% or more by weight of active ingredient. The optimum amount for any given compound will depend upon formulation, application equipment, and nature of the plants to be controlled.

Wettable powders are in the form of finely divided particles that disperse readily in water or other liquid carriers. The particles contain the active ingredient retained in a solid matrix. Typical solid matrices include fuller's earth, kaolin clays, silicas and other readily wet organic or inorganic solids. Wettable powders normally contain about 5% to about 95% of the active ingredient plus a small amount of wetting, dispersing, or emulsifying agent.

Emulsifiable concentrates are homogeneous liquid compositions dispersible in water or other liquid, and may consist entirely of the active compound with a liquid or solid emulsifying agent, or may also contain a liquid carrier, such as xylene, heavy aromatic naphthas, isophorone and other non-volatile organic solvents. In use, these concentrates are dispersed in water or other liquid and normally applied as a spray to the area to be treated. The amount of active ingredient may range from about 0.5% to about 95% of the concentrate.

Granular formulations include both extrudates and relatively coarse particles, and are usually applied without dilution to the area in which suppression of vegetation is desired. Typical carriers for granular formulations include sand, fuller's earth, attapulgite clay, bentonite clays, montmorillonite clay, vermiculite, perlite and other organic or inorganic materials which absorb or which can be coated with the active compound. Granular formulations normally contain about 5% to about 25% active ingredients which may include surface-active agents such as heavy aromatic naphthas, kerosene and other petroleum fractions, or vegetable oils; and/or stickers such as dextrins, glue or synthetic resins.

Dusts are free-flowing admixtures of the active ingredient with finely divided solids such as talc, clays, flours and other organic and inorganic solids that act as dispersants and carriers.

Microcapsules are typically droplets or granules of the active material enclosed in an inert porous shell which allows escape of the enclosed material to the surroundings at controlled rates. Encapsulated droplets are typically about 1 to 50 microns in diameter.

The enclosed liquid typically constitutes about 50 to 95% of the weight of the capsule, and may include solvent in addition to the active compound. Encapsulated granules are generally porous granules with porous membranes sealing the granule pore openings, retaining the active species in liquid form inside the granule pores. Granules typically range from 1 millimeter to 1 centimeter, preferably 1 to 2 millimeters in diameter.

Granules are formed by extrusion, agglomeration or prilling, or are naturally occurring. Examples of such materials are vermiculite, sintered clay, kaolin, attapulgite clay, sawdust and granular carbon. Shell or membrane materials include natural and synthetic rubbers, cellulosic materials, styrene-butadiene copolymers, polyacrylonitriles, polyacrylates, polyesters, polyamides, polyureas, polyurethanes and starch xanthates.

Other useful formulations for herbicidal applications include simple solutions of the active ingredient in a solvent in which it is completely soluble at the desired concentration, such as acetone, alkylated naphthalenes, xylene and other organic solvents.

These formulations can include wetting, dispersing or emulsifying agents which can facilitate application, for example spray droplet formation, wetting of plant leaves and uptake by plants. Examples are alkyl and alkylaryl sulfonates and sulfates and their salts; polyhydric alcohols; polyethoxylated alcohols; esters and fatty amines. These agents, when used, normally comprise from 0.1% to 15% by weight of the formulation.

If necessary or desired for a particular application or crop, the composition of the present invention may contain an antidotally effective amount of an antidote (also known as a ‘safener’) for component (A) or component (B). Safeners are known in the art and many are commercially available. Examples of suitable antidotes are benoxacor and cloquintocet mexyl.

Further, other biocidally active ingredients or compositions may be combined with the composition of this invention. For example, the compositions may contain, in addition to components (A) and (B), insecticides (for example pyrethroids, permethrin, lambda cyhalothrin, cypermethryn, thiamethoxam, carbamates, organophosphates), fungicides (for example strobilurins, such as azoxystrobin, chlorothalonil, trizoles, such as propiconazole), growth regulators (for example mepiquat chloride), bactericides, acaracides or nematicides, in order to broaden the spectrum of activity.

The composition can be made as a single package containing the herbicides together with other ingredients of the formulation (diluents, emulsifiers, surfactants, etc.). Alternatively the composition can be prepared by tank mixing, in which the components (A) and (B) are mixed, together with other ingredients of the formulation, shortly before use at the grower site, for example by mixing the components in a spray tank or holding tank ready for application.

The invention also relates to the use of the compositions in a method of controlling the growth of undesirable vegetation (weeds), particularly in crops.

It is preferred to apply the compositions of the invention so that the compound (A) is applied at a rate of between 1 and 160 g per hectare, more preferably 1 to 100 g/ha. The preferred amount of compound (B) will vary according to the exact chemical nature of (B) and its herbicidal efficacy. For example, paraquat is applied at between 100 and 1000 g/ha, preferably between 300 and 1000 g/ha. Glyphosate is applied at 100 to 5000 g/ha. Sulfonylureas are applied at rates of 5 to 100 g/ha, preferably 10 to 50 g/ha. Chloroacetamides are applied at 10 to 3500 g/ha, preferably 500 to 3000 g/ha. The ratios of the two components vary for the same reasons. The ratio of (A) to (B) when (B) is paraquat is between 1:1000 and 3:2, preferably between 1:100 and 1:10. The ratio of (A) to (B) when (B) is glyphosate between 1:1000 and 3:2, preferably between 1:100 and 1:10. The ratio of (A) to (B) when (B) is a sulfonylurea is between 1:100 and 30:1, preferably between 1:10 and 5:1. The ratio of (A) to (B) when (B) is a chloroacetamide is between 1:1000 and 3:2, preferably between 1:100 and 1:1. Once it is appreciated that synergy is obtainable by the present invention, it is a routine matter to determine the appropriate level of each component required to achieve the desired level of weed control.

The compositions can be applied to the locus where weed control is desired by a convenient method. The “locus” is intended to include soil, seeds, and seedlings, as well as established vegetation.

The composition can be used over a wide range of crops, for example perennial crops such as vines citrus fruit, olives, pomme stone fruit, nuts, oil palms & rubber and annual arable-crops such as cotton, sugar beet, corn, rice, soya or wheat.

Suitable crops include those which are tolerant to one or more of components (A) or (B), such as glyphosate or gluphosinate. Tolerance means a reduced susceptibility to damage caused by a particular herbicide compared to the conventional crop breeds. The tolerance can be natural tolerance produced by selective breeding or can be artificially introduced by genetic modification of the crop. Tolerance is generally necessary when the compositions are applied to arable crops post emergence (after the crop seedlings become visible).

Component (A) is a PPO inhibitor, also known as a ‘Protox’ inhibitor. A description of certain crops tolerant to PPO inhibitors is given in published PCT patent application WO95/34659 and also in application WO97/32011.

Crops can be modified or bred so as to be tolerant to component (B), for example, EPSPS inhibitors like glyphosate. Certain tolerant crops are now well-known and many are commercially available. For example Clearfield® summer rape (Canola) has been rendered tolerant to imidazolinones, e.g. imazamox, by conventional methods of breeding. RoundupReady® corn, cotton, sugarbeet, soya, and canola are examples of crops that have been rendered tolerant to glyphosate by genetic engineering, and LibertyLink® corn, canola, soya and rice are examples of crops that have been rendered tolerant to gluphosinate by genetic engineering.

The compositions of the invention can be used over crops that contain a combination (‘stack’) of two of these herbicide resistance traits, for example both PPO resistance and glyphosate resistance.

The crops can alternatively, or in addition, be genetically modified to be resistant to other unrelated things such as insects or fungi, for example insect resistant cotton, or corn which is resistant to corn-borer or rootworm. Such resistance traits are well-known and crops having such traits are commercially available.

The composition of the present invention can be applied in a variety of ways known to those skilled in the art, at various concentrations. The composition is useful in controlling the growth of undesirable vegetation by preemergence or postemergence application to the locus where weed control is desired.

These formulations can be applied to the areas where weed control is desired by conventional methods. Dust and liquid compositions, for example, can be applied by the use of power-dusters, broom and hand sprayers and spray dusters. The formulations can also be applied from airplanes as a dust or a spray or by rope wick applications. To modify or control growth of germinating seeds or emerging seedlings, dust and liquid formulations can be distributed in the soil or applied to the soil surface only, by spraying or sprinkling. The formulations can also be applied by addition to irrigation water. Dust compositions, granular compositions or liquid formulations applied to the surface of the soil can be distributed below the surface of the soil by conventional means such as disking, dragging or mixing operations.

Pressurized sprayers, wherein the active ingredient is dispersed in finely-divided form as a result of vaporization of a low boiling dispersant solvent carrier, may also be used. Components (A) and (B) as defined above can also be used in a method for controlling undesirable vegetation comprising separately applying to the locus of such vegetation herbicides (A) and (B), sequentially in either order, as part of a single weed control regime. The components can be each applied to the locus where weed control is desired within a single season. Preferably they are applied close enough together in time for there to be an interaction between the two components (A) and (B). Such a period can be for example within six weeks or each other, more preferably within two weeks, most preferably within one week.

The invention is illustrated by the following, non-limiting, examples;

### EXAMPLES

In the following examples, a compound (A) of Formula (I) was used in which R¹ is —CF₃, R² is Methyl, R³ is —CH₂COOCH₂CH₃, X¹ is F, and X² is Cl (as Formula II)

1. Compound (A) with Paraquat.

In these tests, various weeds were treated with paraquat alone at rates equivalent to 700 g per hectare and 840 g per hectare, compound (A) alone at rates equivalent to 10 g per hectare and 20 g per hectare, and with a mixture of paraquat and compound (A) at rates equivalent to the sum of these. The compositions were formulated as an emulsifyable concentrate (EC).

The weed plots were evaluated after the number of days after application (DAA) indicated in the table.

The results in the table under each application are the percentage of the weeds plants that were killed.

| | | | | | | | paraquat + Pyridine cpd | | | |
|---|---|---|---|---|---|---|---|---|---|---|
| | | | paraquat | | Compound (A) | | 700 + | 700 + | 840 + | 840 + |
| No. | Weed Name | DAA | 700 g/ha | 840 g/ha | 10 g/ha | 20 g/ha | 10 g/ha | 20 g/ha | 10 g/ha | 20 g/ha |
| 1.1 | CONYZA SP. | 5 | 2 | | 37 | 40 | 55 | 89 | | |
| 1.2 | SETARIA SP. | 27 | 0 | | 0 | 25 | 0 | 80 | | |
| 1.3 | SETARIA VIRIDIS | 43 | 0 | | 0 | 23 | 0 | 73 | | |
| 1.4 | LOLIUM RIGIDUM | 41 | 53 | | 27 | 47 | 70 | 87 | | |
| 1.5 | LAMIUM PURPUREUM | 2 | 53 | | 30 | 33 | 77 | 77 | | |
| 1.6 | VERONICA PERSICA | 69 | 25 | | 25 | 100 | 80 | 80 | | |
| 1.7 | DIGITARIA CILIARIS | 51 | 0 | | | 0 | 0 | 68 | | |
| 1.8 | ECHINOCHLOA CRUS-GALLI | 51 | 0 | | 0 | 0 | 0 | 47 | | |
| 1.9 | CONYZA SP. | 5 | 2 | | 37 | 40 | 55 | 89 | | |
| 1.10 | SONCHUS ASPER | 32 | | 0 | 60 | 55 | | | 83 | 83 |
| 1.11 | CYPERUS ROTUNDUS | 56 | | 65 | 0 | 0 | | | 88 | 68 |

It is very clear from the table that mixtures of compound (A) and paraquat show efficacy far in excess of that expected from the individual components over certain of these weeds.

2. Compound (A) with Glyphosate

In these tests, various weeds were treated with glyphosate alone at a rate equivalent to 840 g per hectare, Compound (A) alone at rates equivalent to 10 g per hectare and 20 g per hectare, and with a mixture of glyphosate and Compound (A) at rates equivalent to the sum of these. The compositions were formulated as an emulsifyable concentrate (EC). The weed plots were evaluated after the number of days after application (DAA) indicated in the table.

The results in the table under each application are the percentage of the plants that were killed.

| | | | | | | glyphosate + | |
|---|---|---|---|---|---|---|---|
| | | | | | | compound (A) | |
| | | | Glyphosate Compound (A) | | | 840 g/ha + | 840 g/ha + |
| No. | Weed Species | DAA | 840 g/ha | 10 g/ha | 20 g/ha | 10 g/ha | 20 g/ha |
| 2.1 | CYNODON DACTYLON | 82 | 0 | 0 | 0 | 30 | 30 |
| 2.2 | DIGITARIA SANGUINALIS | 52 | 0 | 0 | 0 | 43 | 55 |
| 2.3 | CYPERUS SP. | 1 | 0 | 0 | 0 | 20 | 18 |
| 2.4 | CYPERUS SP. | 52 | 0 | 0 | 0 | 50 | 70 |
| 2.5 | CYPERUS ROTUNDUS | 2 | 0 | 40 | 75 | 60 | 95 |
| 2.6 | HORDEUM PUSILLUM | 13 | 30 | 60 | 70 | 100 | 100 |

It is very clear from the table that mixtures of Compound (A) and glyphosate show efficacy far in excess of that expected from the individual components

3. Compound (A) with Sulfonylureas
3(a) with Triasulfuron

In these tests, various weeds were treated with triasulfuron alone at a rate equivalent to 26 g per hectare, Compound (A) alone at a rate equivalent to 10 g per hectare, and to a mixture of triasulfuron and Compound (A) at rates equivalent to the sum of these. The compositions were formulated as an emulsifyable concentrate (EC).

The weed plots were evaluated after the number of days after application (DAA) indicated in the Table.

The results in the table under each application are the percentage of the plants that were killed.

| | | | | | Triasulfuron + |
|---|---|---|---|---|---|
| | | | Compound (A) | Triasulfuron | Compound (A) |
| No. | Weed Species | DAA | 10 | 26 | 10 + 26 |
| 3.1 | STELLARIA MEDIA | 30 | 63 | 25 | 94 |

It is very clear from the table that mixtures of the Compound (A) and glyphosate show efficacy far in excess of that expected from the individual components.

3b with Nicosulfluoron

In these tests, various weeds were treated with nicosulfuron alone at a rate equivalent to 35 g per hectare, Compound (A) alone at rates equivalent to 10 g per hectare, 20 g per hectare, and 30 g per hectare and to mixtures of nicosulfuron and Compound (A) at rates equivalent to the sum of these. The compositions were formulated as an emulsifyable concentrate (EC).

The weed plots were evaluated after the number of days after application (DAA) indicated in the table.

The results in the table under each application are the percentage of the plants that were killed.

| | | | | | | | Nicosulfuron + | | |
|---|---|---|---|---|---|---|---|---|---|
| | | | Nico | | | | Compound (A) | | |
| | | | sulfuron | Compound (A) | | | 35 + | 35 + | 35 + |
| No. | Weed Species | DAA | 35 g/ha | 5 g/ha | 10 g/ha | 20 g/ha | 5 g/ha | 10 g/ha | 20 g/ha |
| 3.2 | SESBANIA EXALTATA | 45 | 0 | 65 | 85 | 90 | 75 | 90 | |
| 3.3 | SESBANIA EXALTATA | 44 | 10 | 75 | 85 | 90 | 90 | 80 | 95 |
| 3.4 | SETARIA SP. | 21 | 70 | 50 | 80 | 93 | 90 | 80 | |
| 3.5 | DIGITARIA SANGUINALIS | 21 | 70 | 50 | 80 | 93 | 90 | 80 | |
| 3.6 | DIGITARIA SANGUINALIS | 4 | 10 | 20 | 90 | 98 | 65 | 60 | 98 |
| 3.7 | CYPERUS ESCULENTUS | 7 | 0 | 40 | 60 | 60 | 60 | 80 | |
| 3.8 | CHENOPODIUM SP. | 5 | 50 | 20 | 30 | 95 | 70 | 60 | 95 |
| 3.9 | CYPERUS ESCULENTUS | 12 | 0 | 0 | 0 | 30 | 40 | 70 | 75 |
| 3.10 | IPOMOEA SP. | 5 | 0 | 30 | 80 | 95 | 95 | 95 | 95 |
| 3.11 | SETARIA VIRIDIS | 4 | 20 | 40 | 70 | 85 | 75 | 98 | |
| 3.12 | AMARANTHUS RUDIS | 58 | 0 | 50 | 70 | 97 | 80 | 97 | |
| 3.13 | ABUTILON THEOPHRASTI | 27 | 50 | 0 | 98 | 99 | 94 | 95 | 100 |
| 3.14 | DIGITARIA SANGUINALIS | 5 | 0 | 25 | 50 | 99 | 90 | 80 | 90 |
| 3.15 | AMBROSIA TRIFIDA | 28 | 0 | 50 | 50 | 60 | 25 | 60 | 75 |
| 3.16 | BRACHIARIA PLATYPHYLLA | 24 | 35 | 0 | 0 | 0 | 50 | 25 | |
| 3.17 | BRACHIARIA PLATYPHYLLA | 30 | 30 | 0 | 0 | 0 | 40 | 30 | |
| 3.18 | COMMELINA SP. | 10 | 0 | 30 | 50 | 58 | 50 | 98 | 98 |
| 3.19 | COMMELINA SP. | 17 | 0 | 20 | 30 | 50 | 60 | 99 | 99 |

3(c) Mixture with Primisulfuron

In these tests, various weeds were treated with primisulfuron alone at a rate equivalent to 35 g per hectare, Compound (A) alone at rates equivalent to 10 g per hectare, 20 g per hectare, and 30 g per hectare and to mixtures of primisulfuron and Compound (A) at rates equivalent to the sum of these. The compositions were formulated as an emulsifiable concentrate (EC).

The weed plots were evaluated after the number of days after application (DAA) indicated in the table.

The results in the tables under each application are the percentage of the plants that were killed.

| Trial | Weed | | Primisulfuron (g/ha) | | | Compound (A) (g/ha) | | |
|---|---|---|---|---|---|---|---|---|
| No | Species | DAA | 30 | 15 | 7.5 | 5 | 2.5 | 1.25 |
| 3.20 | Euphorbia | 45 | 50 | 30 | 10 | 70 | 70 | 50 |
| 3.21 | Ipomoea | 44 | 25 | 20 | 0 | 100 | 100 | 80 |

| | | | Primisulfuron + Compound (A) (g/ha) | | | | | | | | |
|---|---|---|---|---|---|---|---|---|---|---|---|
| | Weed | | 30 + | 15 + | 7.5 + | 30 + | 15 + | 7.5 + | 30 + | 15 + | 7.5 + |
| Trial No | Species | DAA | 5 | 5 | 5 | 2.5 | 2.5 | 2.5 | 1.25 | 1.25 | 1.25 |
| 3.22 | Euphorbia | 45 | 98 | 98 | 98 | 90 | 80 | 80 | 90 | 80 | 80 |
| 3.23 | Ipomoea | 44 | 100 | 100 | 100 | 100 | 100 | 100 | 100 | 90 | 90 |

3(d) Mixture with Prosulfuron

In these tests, various weeds were treated with prosulfinuron alone at a rate equivalent to 35 g per hectare, Compound (A) alone at rates equivalent to 10 g per hectare, 20 g per hectare, and 30 g per hectare and to mixtures of prosulfuron and Compound (A) at rates equivalent to the sum of these. The compositions were formulated as an emulsifiable concentrate (EC).

The weed plots were evaluated after the number of days after application (DAA) indicated in the table.

The results in the tables under each application are the percentage of the plants that were killed.

| | Weed | | Prosulfuron (g/ha) | | | Compound (A) (g/ha) | | |
|---|---|---|---|---|---|---|---|---|
| No. | Species | DAA | 30 | 15 | 7.5 | 5 | 2.5 | 1.25 |
| 3.24 | Galium | 13 | 70 | 40 | 30 | 100 | 50 | 50 |
| 3.25 | Veronica | 13 | 15 | 0 | 0 | 100 | 100 | 80 |
| 3.26 | Corn | 13 | 0 | 0 | 0 | 98 | 90 | 70 |
| 3.27 | Brachiaria | 13 | 0 | 0 | 0 | 98 | 60 | 50 |
| 3.28 | Euphorbia | 13 | 30 | 20 | 20 | 70 | 70 | 50 |
| 3.29 | Rice | 13 | 0 | 0 | 0 | 90 | 70 | 50 |
| 3.30 | Wheat | 13 | 0 | 0 | 0 | 100 | 95 | 80 |

| | | | Prosulfuron + Compound (A) (g/ha) | | | | | | | | |
|---|---|---|---|---|---|---|---|---|---|---|---|
| | Weed | | 30 + | 15 + | 7.5 + | 30 + | 15 + | 7.5 + | 30 + | 15 + | 7.5 + |
| No. | Species | DAA | 5 | 5 | 5 | 2.5 | 2.5 | 2.5 | 1.25 | 1.25 | 1.25 |
| 3.31 | Galium | 13 | 90 | 90 | 80 | 70 | 70 | 70 | 50 | 50 | 50 |
| 3.32 | Veronica | 13 | 100 | 100 | 100 | 100 | 100 | 100 | 100 | 100 | 100 |
| 3.33 | Corn | 13 | 100 | 100 | 95 | 98 | 95 | 90 | 80 | 60 | 60 |
| 3.34 | Brachiaria | 13 | 100 | 100 | 100 | 90 | 90 | 50 | 90 | 90 | 40 |
| 3.35 | Euphorbia | 13 | 98 | 98 | 90 | 100 | 90 | 90 | 100 | 100 | 100 |
| 3.36 | Rice | 13 | 95 | 95 | 95 | 60 | 60 | 60 | 60 | 50 | 40 |
| 3.37 | Wheat | 13 | 100 | 100 | 100 | 100 | 100 | 100 | 90 | 100 | 100 |

4. Mixture with S-metolachlor

In these tests, various weeds were treated with S-metolachlor (SMOC) alone at an application rate equivalent to 1420 g per hectare, Compound (A) alone at rates equivalent to 20 g per hectare and 20 g per hectare and with mixtures of S-metolachlor and the Compound (A) at rates equivalent to the sum of these. The compositions were formulated as an emulsifyable concentrate (EC).

The weed plots were evaluated after the number of days after application (DAA) indicated in the table.

The results in the table under each application are the percentage of the plants that were killed.

| | | | | | | SMOC + Compound (A) | |
|---|---|---|---|---|---|---|---|
| | | | Compound (A) | | SMOC | 1420 + | 1420 + |
| Trial No | Weed Name | DAA | 20 g/ha | 40 g/ha | 1420 g/ha | 20 g/ha | 40 g/ha |
| 4.1 | ECHINOCHLOA CRUS-GALLI | 28 | 53 | 55 | 75 | 93 | 73 |
| 4.2 | SESBANIA EXALTATA | 56 | 50 | 25 | 20 | 73 | 83 |
| 4.3 | ABUTILON THEOPHRASTI | 23 | 43 | 78 | 13 | 80 | 93 |
| 4.4 | ABUTILON THEOPHRASTI | 38 | 35 | 70 | 0 | 60 | 80 |
| 4.5 | CHENOPODIUM ALBUM | 26 | 80 | 80 | 0 | 92 | 97 |
| 4.6 | CHENOPODIUM ALBUM | 54 | 0 | 44 | 0 | 85 | 74 |
| 4.7 | AMBROSIA ARTEMISIIFOLIA | 25 | 47 | 79 | 30 | 86 | 97 |
| 4.8 | AMBROSIA ARTEMISIIFOLIA | 49 | 30 | 69 | 30 | 78 | 85 |
| 4.9 | IPOMOEA SP. | 25 | 35 | 65 | 0 | 65 | 87 |
| 4.10 | IPOMOEA SP. | 49 | 20 | 60 | 0 | 65 | 79 |
| 4.11 | CHENOPODIUM ALBUM | 56 | 0 | 13 | 0 | 18 | 23 |
| 4.12 | ABUTILON THEOPHRASTI | 15 | 25 | 88 | 65 | 80 | 97 |
| 4.13 | ABUTILON THEOPHRASTI | 56 | 0 | 13 | 0 | 13 | 0 |
| 4.14 | POLYGONUM PENSYLVANICUM | 56 | 0 | 13 | 0 | 0 | 30 |
| 4.15 | AMBROSIA TRIFIDA | 42 | 23 | 38 | 25 | 80 | 85 |
| 4.16 | AMBROSIA TRIFIDA | 8 | 75 | 95 | 25 | 95 | 97 |
| 4.17 | XANTHIUM STRUMARIUM | 26 | 25 | 73 | 38 | 90 | 95 |
| 4.18 | XANTHIUM STRUMARIUM | 42 | 23 | 68 | 30 | 63 | 65 |

It is very clear from the table that mixtures of Compound (A) and S-metolachlor show efficacy far in excess of that expected from the individual components over certain of these weeds

5. Mixture with Sulcotrione

In these tests, various weeds were treated with sulcotrione alone at an application rate equivalent to 1420 g per hectare, Compound (A) alone at rates equivalent to 20 g per hectare and 20 g per hectare and with mixtures of S-metolachlor and Compound (A) at rates equivalent to the sum of these. The compositions were formulated as an emulsifyable concentrate (EC).

The weed plots were evaluated after the number of days after application (DAA) indicated in the table.

The results in the table under each application are the percentage of the plants that were killed.

| | | | Compound | | Sulcotrione | | | Compound (A) + sulcotrione (g/ha) | | | | | |
|---|---|---|---|---|---|---|---|---|---|---|---|---|---|
| | Weed | | (A) (g/ha) | | (g/ha) | | | 1.25 + | 1.25 + | 1.25 + | 5 + | 5 + | 5 + |
| Trial No | Name | DAA | 1.25 | 5 | 200 | 100 | 50 | 200 | 100 | 50 | 200 | 100 | 50 |
| 5.1 | Cyperus | 14 | 50 | 50 | 30 | 30 | 25 | 90 | 50 | 50 | 90 | 80 | 70 |

What is claimed is:

1. A herbicidal composition comprising;
(A) a herbicide of formula (I) 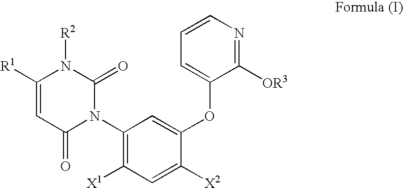
in which R¹ is C1 to C3 alkyl or C1 to C3 haloalkyl. R² is C1 to C3 alkyl, X¹ and X² are halogen and R³ is a C1-6 alkanoic acid C1-6 alkyl ester residue, and:
(B) a second herbicide selected from;
(B1) paraquat
(B2) glyphosate
(B3) a sulfonylurea
(B4) a chloroacetamide
(B5) a diphenyl ether
(B6) a triazine
(B7) a N-phenylphthalimide
(B8) glufosinate
(B9) a phenylpyridazine
(B30) a triketone
(B11) an isoxazole
(B12) a cyclohexanedione oxime
(B13) a triazolinone
(B14) a urea
(B15) a dinitroaniline
(B16) a pinoxaden
or their herbicidally effective salts.

2. A composition according to claim 1, wherein component. (B) is selected from (B1) paraquat, (B2) glyphosate, (B3) a sulfonyl urea, (B4) a chloroanilide or (B10) a triketone, or their herbicidally effective salts.

3. A composition according to claim 1 in which R¹ is methyl substituted with fluorine.

4. A composition according to claim 1 in which R¹ is trifluoromethyl.

5. A composition according to claim 1 in which R² is methyl or ethyl, more preferably methyl.

6. A composition according to claim 1 in which R³ is CH₂COOCH₂CH₃

7. A composition according to claim 1 in which X¹ and X² are independently chlorine or fluorine.

8. A composition according to claim 1 in which X¹ is fluorine and X² is chlorine.

9. A method for controlling undesirable vegetation, comprising applying to the locus of such vegetation a herbicidally effective amount of a composition as claimed in claim 1.

10. A method for controlling undesirable vegetation comprising separately applying to the locus of such vegetation herbicides (A) and (B) as defined in claim 1
